(19) United States
(12) Patent Application Publication
(10) Pub. No.: US 2025/0074455 A1
(43) Pub. Date: Mar. 6, 2025

(54) METHOD AND SYSTEM FOR AUTOMATICALLY GENERATING VIRTUAL DRIVING ENVIRONMENT USING REAL-WORLD DATA FOR AUTONOMOUS VEHICLE

(71) Applicant: Wipro Limited, Bangalore (IN)

(72) Inventors: Mohd ZAID, New Delhi (IN); Yuvika Dev SHARMA, Bangalore (IN)

(73) Assignee: Wipro Limited, Bangalore (IN)

(21) Appl. No.: 18/501,122

(22) Filed: Nov. 3, 2023

(30) Foreign Application Priority Data
Sep. 5, 2023 (IN) 202341059635

(51) Int. Cl. B60W 60/00; B60W 40/06

(52) U.S. Cl. CPC B60W 60/001; B60W 40/06; B60W 2554/4049

(57) ABSTRACT

Present disclosure discloses method and system for automatically generating virtual driving environment using real-world data for autonomous vehicle (AV). Method extracts object feature data and road feature data from information related to an environment surrounding the AV. Thereafter, method generates a dynamic tree-based model for one or more objects in the environment with reference to the AV based on the object feature data and road network information based on the road feature data. Subsequently, method generates a pre-virtual driving environment by combining the dynamic tree-based model for the one or more objects and the road network information using a tree traversal technique and validates the pre-virtual driving environment for inaccuracies based on configurable validation rules. Lastly, method corrects the information based on the inaccuracies obtained during the validation using a cognitive technique and re-generates the virtual driving environment for the AV using the pre-virtual driving environment and the corrected information.

### TECHNICAL FIELD

The present subject matter generally relates to an autonomous driving technique, more particularly, to a method and a virtual driving environment generating system for automatically generating virtual driving environment using real-world data for an Autonomous Vehicle (AV).

### BACKGROUND

In the field of AV development, there is always a need for simulation testing. Simulation testing is one of the essential pre-requisites before deploying a software to an actual vehicle for field testing, which is costly, risky and tedious. Simulator/simulation system is a platform used for creating virtual driving environment comprising several real-world traffic scenarios used for testing and validation of the software. Conventional simulation systems do not consider automatic environment and scenario generation. Generally, a developer has to model a virtual driving environment manually to match the accuracy of a real-world environment. This process is very tedious and time consuming as the real-world environment consist of lots of minute details which need to be considered and modelled accordingly. Any mismatch or gap in implementation of these details can result in loss of information (which could be an important factor in software's decision making) and consequently, can alter vehicle's manoeuvring behaviour.

The information disclosed in this background of the disclosure section is for enhancement of understanding of the general background of the invention and should not be taken as an acknowledgement or any form of suggestion that this information forms the prior art already known to a person skilled in the art.

### SUMMARY

Embodiments of the present disclosure addresses the problems associated with generating virtual driving environment.

In an embodiment, there is a method provided for generating a virtual driving environment for an Autonomous Vehicle (AV). The method extracts object feature data and road feature data from information related to an environment surrounding the AV. Thereafter, the method generates a dynamic tree-based model for one or more objects in the environment surrounding the AV with reference to the AV based on the object feature data and road network information based on the road feature data. Subsequently, the method generates a pre-virtual driving environment by combining the dynamic tree-based model for the one or more objects and the road network information using a tree traversal technique and validates the pre-virtual driving environment for inaccuracies based on configurable validation rules. Lastly, the method corrects the information based on the inaccuracies obtained during the validation of the pre-virtual driving environment using a cognitive technique and re-generates the virtual driving environment for the AV using the pre-virtual driving environment and the corrected information.

In an embodiment, there is a virtual driving environment generating system provided for generating a virtual driving environment for an Autonomous Vehicle (AV). The virtual driving environment generating system includes a processor and a memory communicatively coupled to the processor, wherein the memory stores processor-executable instructions, which on execution by the processor, cause the processor to extract object feature data and road feature data from information related to an environment surrounding the AV. Thereafter, the processor is configured to generate a dynamic tree-based model for one or more objects in the environment surrounding the AV with reference to the AV based on the object feature data and road network information based on the road feature data. Subsequently, the processor is configured to generate a pre-virtual driving environment by combining the dynamic tree-based model for the one or more objects and the road network information using a tree traversal technique and validate the pre-virtual driving environment for inaccuracies based on configurable validation rules. Lastly, the processor is configured to correct the information based on the inaccuracies obtained during the validation of the pre-virtual driving environment using a cognitive technique and re-generate the virtual driving environment for the AV using the pre-virtual driving environment and the corrected information.

In an embodiment, there is a non-transitory computer readable medium including instructions stored thereon that when processed by at least one processor cause a virtual driving environment generating system to perform act of extracting object feature data and road feature data from information related to an environment surrounding the AV. Thereafter, the instructions cause the at least one processor to generate a dynamic tree-based model for one or more objects in the environment surrounding the AV with reference to the AV based on the object feature data and road network information based on the road feature data and generate a pre-virtual driving environment by combining the dynamic tree-based model for the one or more objects and the road network information using a tree traversal technique. Subsequently, the instructions cause the at least one processor to validate the pre-virtual driving environment for inaccuracies based on configurable validation rules and correct the information based on the inaccuracies obtained during the validation of the pre-virtual driving environment using a cognitive technique. Lastly, the instructions cause the at least one processor to re-generate the virtual driving environment for the AV using the pre-virtual driving environment and the corrected information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and together with the description, serve to explain the disclosed principles. The same numbers are used throughout the figures to reference like features and components. Some embodiments of system and/or methods in accordance with embodiments of the present subject matter are now described below, by way of example only, and with reference to the accompanying figures.

FIG. 1 illustrates an environment for generating a virtual driving environment for an AV in accordance with some embodiments of the present disclosure.

FIG. 2a shows a detailed block diagram of a virtual driving environment generating system in accordance with some embodiments of the present disclosure.

FIG. 2b illustrates an example of extracting object feature data in accordance with some embodiments of the present disclosure.

FIG. 2c illustrates an example of extracting road feature data in accordance with some embodiments of the present disclosure.

FIG. 2d illustrates an example of a dynamic tree-based model for objects in accordance with some embodiments of the present disclosure.

FIG. 2e illustrates an example of generated road network information based on road feature data in accordance with some embodiments of the present disclosure.

FIG. 2f illustrates an example of dynamic list linking road segments in accordance with some embodiments of the present disclosure.

FIG. 2g illustrates an example of a tangent system for an object orientation in accordance with some embodiments of the present disclosure.

FIG. 2h illustrates an example of spline diagram for nodes in a pre-virtual driving environment in accordance with some embodiments of the present disclosure.

FIG. 2i illustrates an example of validation and correction of a pre-virtual driving environment in accordance with some embodiments of the present disclosure.

FIG. 2j illustrates an example of a virtual driving environment in accordance with some embodiments of the present disclosure

FIG. 3 illustrates a flowchart showing a method of generating a virtual driving environment for an AV in accordance with some embodiments of present disclosure.

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of embodiments of the disclosure, reference is made to the accompanying drawings which illustrates specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure provides a method and a system for generating a virtual driving environment for an Autonomous Vehicle (AV). The present disclosure uses information related to an environment surrounding the AV captured/received from one or more sensors to generate a pre-virtual driving environment. This pre-virtual driving environment is then validated based on configurable validation rules and corrected for inaccuracies/noise obtained during the validation to generate a (final or realistic) virtual driving environment for the AV. The approach in the present disclosure has following technical advantages: (1) The present disclosure automates the process of virtual driving environment generation by generating a pre-virtual driving environment, validating the pre-virtual driving environment for inaccuracies/noise and correcting the information based on the inaccuracies. This approach improves accuracy and efficiency of the virtual driving environment generation process. (2) Typically, a virtual driving environment is created manually using one or more developers. This manual process is tedious and time consuming, and consequently, there is a high possibility to miss lots of minute details of a real-world environment in generating the virtual driving environment. The present disclosure overcomes these problems associated with the manual process. (3) The present disclosure allows generation of new synthetic dataset to be used by machine learning algorithms for training purpose and validation purpose. (4) Any mismatch or gap in collected/received information related to an environment surrounding the AV can alter vehicle's manoeuvring behaviour. The present disclosure allows coverage of static as well as dynamic objects related to the environment surrounding the AV into the virtual driving environment using one or more sensors to avoid any loss of information. (5) The present disclosure considers road network information such as a length of a road, a width of the road, an elevation of the road and a curvature of the road along with dynamic state of objects such as pedestrian(s) and vehicle(s) to provide a realistic virtual driving environment.

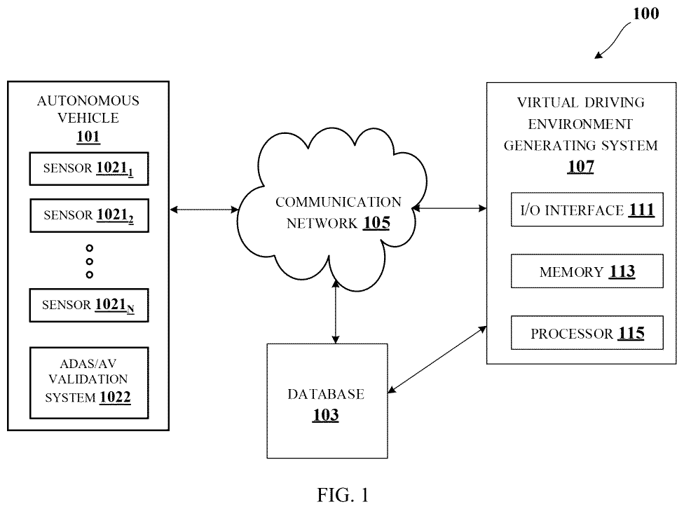

FIG. 1 illustrates an environment for generating a virtual driving environment for an AV in accordance with some embodiments of the present disclosure.

In the FIG. 1, the environment 100 includes an AV 101 on which one or more sensors 10211, 10212 . . . 1021N (collectively referred as 1021 hereafter) are positioned, a database 103, a communication network 105 and a virtual driving environment generating system 107. In one embodiment, the AV 101 may include an Advanced Driver Assistance System (ADAS)/Autonomous vehicles (AV) validation system 1022 to assist drivers of AV 101 during driving and/or parking of the AV 101. The AV 101 can be any vehicle that transports people or cargo such a car, a truck, a bus, and the like. The one or more sensors 1021 positioned on the AV 101 comprise at least one of a camera, a Light Detection and Ranging (LIDAR) sensor, a Radio Detection And Ranging (RADAR) sensor, a Global Positioning System (GPS) sensor, an Inertial Measurement Unit (IMU) sensor, accelerometer sensors and an ultrasonic sensor. The one or more sensors 1021 capture and send information related to an environment surrounding the AV to the virtual driving environment generating system 107 using the communication network 105. The information related to the environment surrounding the AV comprises at least one of environmental data, odometer data, Simultaneous Localization and Mapping (SLAM) data, and data related to vehicles, road network, markings on roads, pedestrians, sign-boards, traffic, vegetation and traffic lights. The communication network 105 can be any of the following, but is not limited to, communication protocols/methods: a direct interconnection, an e-commerce network, a Peer-to-Peer (P2P) network, Local Area Network (LAN), Wide Area Network (WAN), wireless network (for example, using Wireless Application Protocol), Internet, Wi-Fi, Bluetooth and the like. In one embodiment, the one or more sensors 1021 are a part of the virtual driving environment generating system 107, especially, an input capturing module (discussed later in detail).

In the embodiment, the virtual driving environment generating system 107 may include an Input/Output (I/O) interface 111, a memory 113, and a processor 115. The I/O interface 111 is configured to receive the information from the one or more sensors 1021 positioned on the AV 101. The I/O interface 111 employs communication protocols/methods such as, without limitation, audio, analog, digital, monoaural, Radio Corporation of America (RCA) connector, stereo, IEEE®-1394 high speed serial bus, serial bus, Universal Serial Bus (USB), infrared, Personal System/2 (PS/2) port, Bayonet Neill-Concelman (BNC) connector, coaxial, component, composite, Digital Visual Interface (DVI), High-Definition Multimedia Interface (HDMI®), Radio Frequency (RF) antennas, S-Video, Video Graphics Array (VGA), IEEE® 802.11b/g/n/x, Bluetooth, cellular e.g., Code-Division Multiple Access (CDMA), High-Speed Packet Access (HSPA+), Global System for Mobile communications (GSM®), Long-Term Evolution (LTE®), Worldwide interoperability for Microwave access (WiMax®), or the like.

The information received by the I/O interface 111 is stored in the memory 113. The memory 113 is communicatively coupled to the processor 115 of the virtual driving environment generating system 107. The memory 113, also, stores processor-executable instructions which may cause the processor 115 to execute the instructions for generating a virtual driving environment for the AV 101. The memory 113 includes, without limitation, memory drives, removable disc drives, etc. The memory drives may further include a drum, magnetic disc drive, magneto-optical drive, optical drive, Redundant Array of Independent Discs (RAID), solid-state memory devices, solid-state drives, etc.

The processor 115 includes at least one data processor for generating a virtual driving environment for the AV 101. The processor 115 may include specialized processing units such as integrated system (bus) controllers, memory management control units, floating point units, graphics processing units, digital signal processing units, etc.

The database 103 stores information/data related to street/road map i.e., real-world map data (OpenStreetMap (OSM)/HD map data) used for routing or navigation. The database 103 may be referred as Environment/Scenario database. The database 103 is updated at pre-defined intervals of time. These updates relate to the information/data related to the street/road map i.e., OSM/HD map data.

Hereinafter, the operation of the virtual driving environment generating system 107 is explained briefly.

When the AV 101 moves on a road, the one or more sensors 1021 positioned on the AV 101 capture information related to an environment surrounding the AV 101. The information comprises at least one of environmental data, odometer data, Simultaneous Localization and Mapping (SLAM) data, and data related to vehicles, road network, markings on roads, pedestrians, sign-boards, traffic, vegetation and traffic lights. The virtual driving environment generating system 107 receives the information related to the environment surrounding the AV 101 from the one or more sensors 1021 using the communication network 105. In one embodiment, the virtual driving environment generating system 107 receives information/data related to street/road from the database 103. The virtual driving environment generating system 107 extracts object feature data and road feature data from the information. The object feature data comprises a number of one or more objects present in the environment surrounding the AV 101, type of the one or more objects present in the environment surrounding the AV 101, state of the one or more objects, distance of the one or more objects from the AV 101, velocity of the one or more objects with respect to the AV 101, direction of the one or more objects with respect to the AV 101, orientation of the one or more objects with respect to the AV 101, weather present in the environment surrounding the AV 101 and time of day. The one or more objects comprise at least one of one or more pedestrians, one or more vehicles and one or more traffic elements present in the environment surrounding the AV. The road feature data comprises at least one of drivable road region and road information. Thereafter, the virtual driving environment generating system 107 generates a dynamic tree-based model for objects in the environment surrounding the AV 101 with reference to the AV 101 based on the object feature data. The objects comprise at least one of one or more pedestrians and one or more vehicles present in the environment surrounding the AV 101. Subsequently, the virtual driving environment generating system 107 generates a road network information based on the road feature data using a dynamic list technique. The dynamic tree-based model for the one or more objects and the road network information are combined by the virtual driving environment generating system 107 using a tree traversal technique to generate a pre-virtual driving environment. The pre-virtual driving environment is validated for inaccuracies/noise based on configurable validation rules by the virtual driving environment generating system 107. Based on the inaccuracies/noise obtained during the validation of the pre-virtual driving environment, the virtual driving environment generating system 107 corrects the information related to the environment surrounding the AV 101 using a cognitive technique. The virtual driving environment generating system 107 uses the pre-virtual driving environment and the corrected information to re-generate the (final or realistic) virtual driving environment for the AV 101.

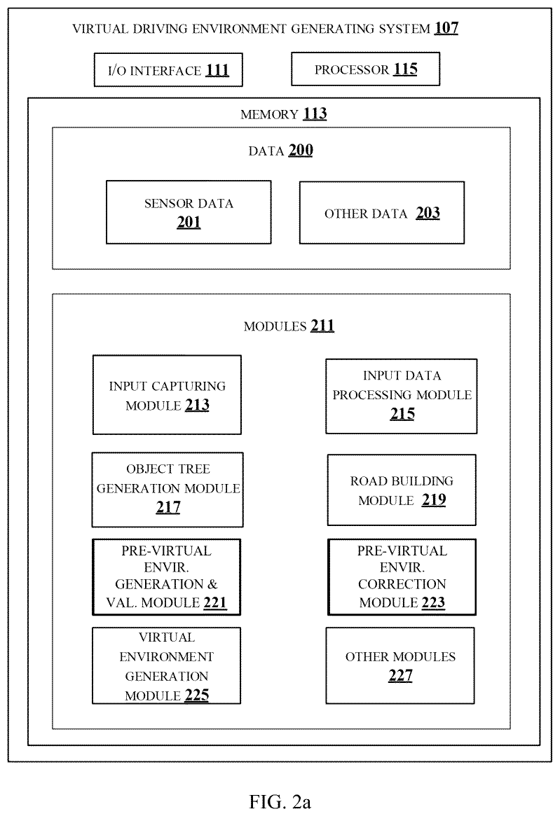

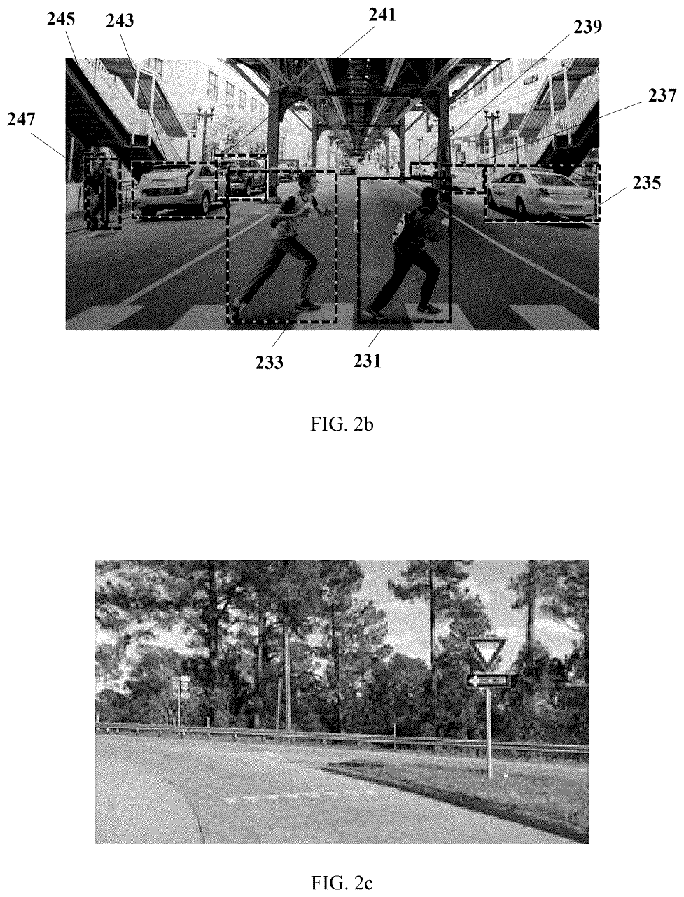

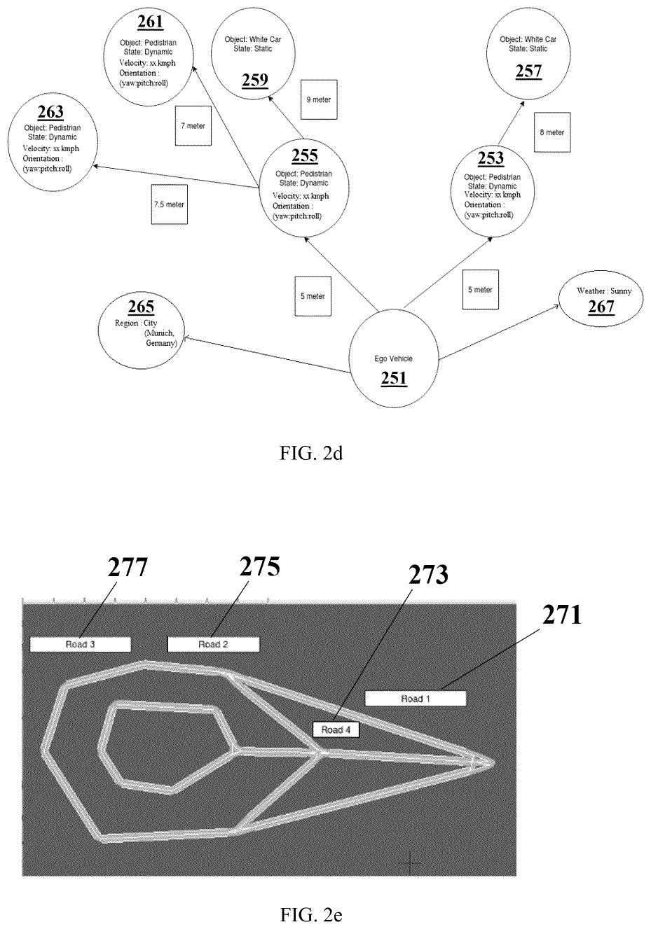

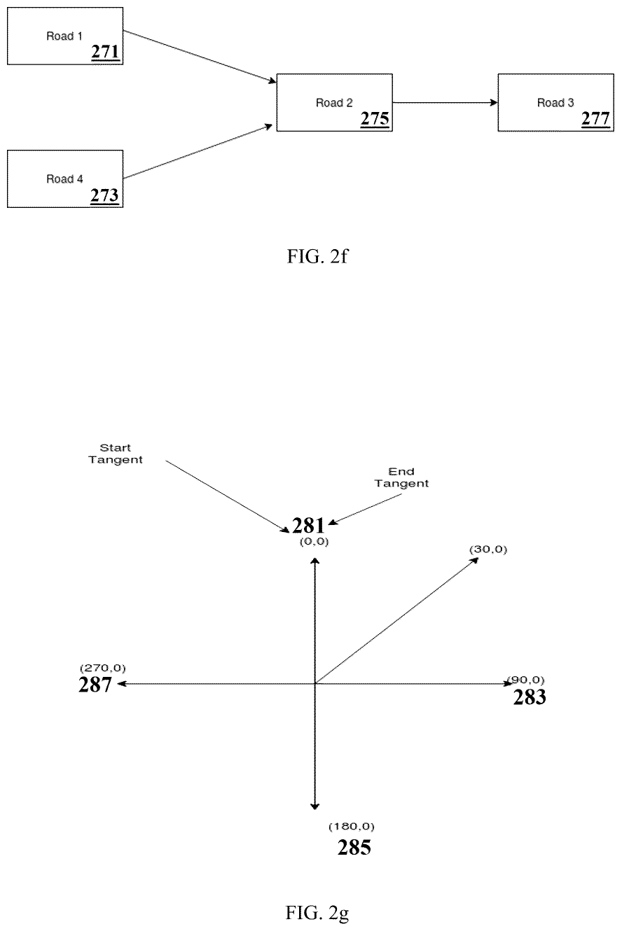

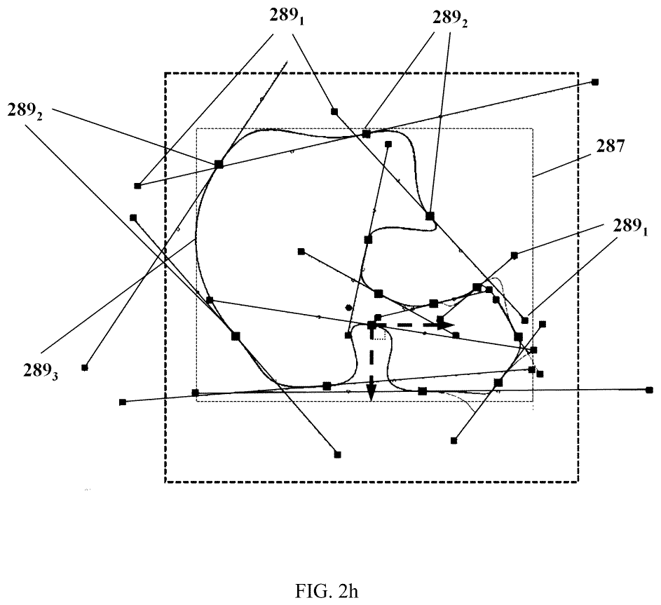

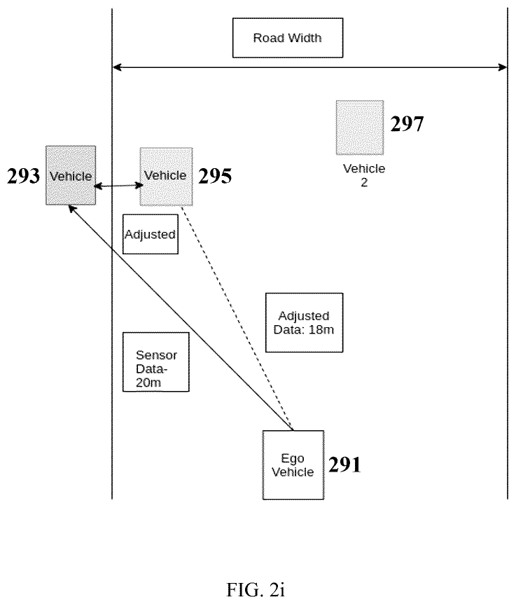

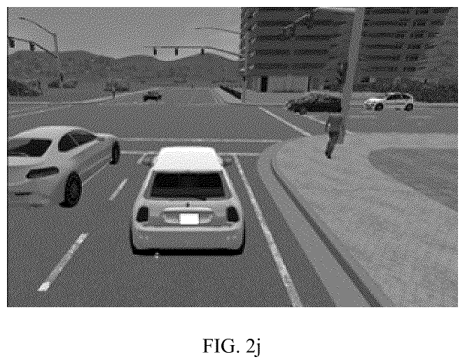

FIG. 2a shows a detailed block diagram of a virtual driving environment generating system in accordance with some embodiments of the present disclosure.

The virtual driving environment generating system 107, in addition to the I/O interface 111 and processor 115 described above, includes data 200 and one or more modules 211, which are described herein in detail. In the embodiment, the data 200 may be stored within the memory 113. The data 200 include, for example, sensor data 201 and other data 203.

The sensor data 201 includes at least one of environmental data, odometer data, SLAM data, and data related to vehicles, road network, markings on roads, pedestrians, sign-boards, traffic, vegetation and traffic lights.

The other data 203 stores data, including temporary data and temporary files, generated by one or more modules 211 for performing the various functions of the virtual driving environment generating system 107.

In the embodiment, the data 200 in the memory 113 are processed by the one or more modules 211 present within the memory 113 of the virtual driving environment generating system 107. In the embodiment, the one or more modules 211 are implemented as dedicated hardware units. As used herein, the term module refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality. In some implementations, the one or more modules 211 are communicatively coupled to the processor 115 for performing one or more functions of the virtual driving environment generating system 107. The said modules 211 when configured with the functionality defined in the present disclosure results in a novel hardware.

In one implementation, the one or more modules 211 include, but are not limited to, an input capturing module 213, an input data processing module 215, an object tree generation module 217, a road building module 219, a pre-virtual environment generation and validation module 221, a pre-virtual environment correction module 223 and a virtual environment generation module 225. The one or more modules 211, also, includes other modules 225 to perform various miscellaneous functionalities of the virtual driving environment generating system 107.

The input capturing module 213: The input capturing module 213 captures information related to an environment surrounding the AV 101 using one or more sensors 1021. The one or more sensors 1021 are mounted/positioned on the AV 101 in such a way that the entire scene/environment surrounding the AV 101 is clearly captured. For instance, in the AV 101, a camera is placed in such a way that camera's field of view is as broad as possible, so that the camera can cover most of the surrounding scene/environment. A LIDAR sensor is placed on top of the AV 101 and perpendicular to the axis of the ground. GPS sensor and RADAR sensor are placed at the top and the front of the AV 101, respectively. The one or more sensors 1021 comprise at least one of a camera, a LIDAR sensor, a RADAR sensor, a GPS sensor, an IMU sensor, accelerometer sensors and an ultrasonic sensor. The information comprises at least one of environmental data, odometer data, SLAM data, and data related to vehicles, road network, markings on roads, pedestrians, sign-boards, traffic, vegetation and traffic lights. In one embodiment, the Input capturing module 213 receives information/data related to street/road from the database 103.

The input data processing module 215: The input data processing module 215 processes the information received from the input capturing module 213. This module 215 extracts object feature data and road feature data from the information. The input data processing module 215 processes the information using cognitive Artificial Intelligence (AI) algorithms to extract the object feature data present in the environment surrounding the AV 101 as shown in FIG. 2b. For instance, the input data processing module 215 processes the information from the LIDAR sensor and the RADAR sensor to calculate distance of the one or more objects from the AV 101 and velocity of the one or more objects with respect to the AV 101. The one or more objects comprise at least one of one or more pedestrians 231, 233, 245, 247, one or more vehicles 235, 237, 239, 241, 243 and one or more traffic elements presents in the environment surrounding the AV 101. The input data processing module 215 extracts following object feature data present in the environment surrounding the AV 101:
(a) a number of one or more objects present in the environment surrounding the AV 101,
(b) type of the one or more objects present in the environment surrounding the AV 101,
(c) state of the one or more objects i.e., static object or/and dynamic object,
(d) distance of the one or more object from the AV 101,
(e) velocity of the one or more objects with respect to the AV 101,
(f) direction of the one or more objects with respect to the AV 101,
(g) orientation of the one or more objects with respect to the AV 101 i.e., front-facing or back-facing for the dynamic objects such as vehicles, pedestrians and the like,
(h) region or location i.e., area, state, or country in which the AV 101 is present, and
(i) weather present in the environment surrounding the AV 101 i.e., cloudy, rainy, or sunny and time of day. In one embodiment, weather, also, includes time of the day such as night time, evening time or morning time present around the AV 101. The information from the camera and other sensors are fused together to detect the weather around the AV 101. For instance, in rainy scenario, priority is given to the information from the RADAR sensor as the camera and the LIDAR sensor have low accuracy in these conditions. In fog scenario, priority is given to the information from the LIDAR sensor and the RADAR sensor rather than the camera due to low visibility.

The input data processing module 215 sends the extracted object feature data to the object tree generation module 217.

The input data processing module 215 processes the information received from the input capturing module 213 to the road feature data. The road feature data comprises at least one of drivable road region and road information as shown in FIG. 2c. For instance, the input data processing module 215 processes the information from the camera to extract drivable road region by applying semantic segmentation technique and parses information/data related to street/road map in the database (i.e., environment/scenario database) 103 to extract the road information.

The input data processing module 215 sends the extracted road feature data to the road building module 219.

The input data processing module 215, also, receives corrected information (as explained below) to re-generate corrected object feature data and corrected road feature data.

The object tree generation module 217: The object tree generation module 217 generates a dynamic tree-based model for objects in the environment surrounding the AV 101 with reference to the AV 101 251 based on the object feature data from the input data processing module 215. The object tree generation module 217, for each object, forms a node 253, 255, 257, 259, 261, 263, 265, 267 of the dynamic tree-based model consisting of object feature data information including distance of the one or more object from the AV 101, type of the one or more objects present in the environment surrounding the AV 101 i.e., vehicle, pedestrian, and the like, state of the one or more objects i.e., static object or/and dynamic object, weather and region as shown in FIG. 2D. The object tree generation module 217, for dynamic objects, also uses velocity of the one or more objects with respect to the AV 101 and orientation of the one or more objects with respect to the AV 101 in the node of the dynamic tree-based model. For instance, if an object is missed in couple of frames (in the information captured by the one or more sensors 1021) due to occlusion, that information is also maintained in tree to produce similar edge case effect in virtual driving environment. Each object is tracked to generate a similar movement inside the virtual driving environment. As the AV 101 moves in front the distance to some object nodes become zero and all those with static state gets added as back nodes to the AV 101 (ego vehicle) node 251 (in the tree). This results in maintaining same backward connectivity between other static object nodes (like during forward movement), which can help in vehicle reversal manoeuvre along with information of other dynamic objects for example in parking scenarios.

The object tree generation module 217 forms a separate node for the information on weather in construction of the dynamic tree-based model.

The object tree generation module 217 also re-builds the dynamic tree-based model based on the correct object feature data received from the input data processing module 215.

The road building module 219: The road building module 219 generates a road network information such as a length of a road, a width of the road, an elevation of the road and a curvature of the road based on the road feature data using a dynamic list technique. This module 219, based on the road feature data, generates an outer mesh of the road (shown in FIG. 2e) and passes the outer mesh of the road to a dynamic list. The dynamic list consists of all the information regarding the connection of one road segment with the other road segment as shown in FIG. 2f. The information used for building dynamic list also comes from the information from the GPS sensor, the SLAM data and the odometer data. The dynamic list is a queue-based list consisting of all the road segments 271, 273, 275, 277 in order as shown in FIG. 2f. As the AV 101 passes from one road segment to the other road segment, the previous road segment is popped/removed and when the AV 101 find new road segment, the new road segment gets added to the end of the dynamic list. Each node in the queue can act as a stack of node which takes care of scenarios where the AV 101 has multiple road segments attaching to a single road segment or vice versa. As an example, in FIG. 2f, road 1 271 and road 4 273 are joining road 2 275 segment. In this case, one dynamic list is road 1 271, road 2 275, and road 3 277 and the other dynamic list is road 4 273, road 2 275, and road 3 277. The processing of each road segment is done individually.

The road building module 219 also re-generates the correct road network information using the dynamic list technique based on the correct road feature data received from the input data processing module 215.

The pre-virtual environment generation and validation module 221: The pre-virtual environment generation and validation module 221 generates a pre-virtual driving environment by combining the dynamic tree-based model for the one or more objects and the road network information using a tree traversal technique that gets converted into a dynamic list. The pre-virtual environment generation and validation module 221, also, validates the pre-virtual driving environment for inaccuracies/noise based on configurable validation rules. The pre-virtual environment generation and validation module 221, also, maintains overall context of the driving environment i.e., the environment surrounding the AV 101, which is used to generate a pre-virtual driving environment.

The pre-virtual environment generation and validation module 221 converts the dynamic tree-based model for the one or more objects from the object tree generation module 217 and the road network information from the road building module 219 into dictionary data (shown in Table 1) using a tree traversal algorithm. The tree traversal technique is a breadth-first search technique. The pre-virtual environment generation and validation module 221 loads each node (object) of the dynamic tree-based model with its state into the dictionary and the distance from the AV 101 of each node is added to the start point and end point of the dictionary in form of co-ordinates 281, 283, 285, 287. The pre-virtual environment generation and validation module 221 also adds the start tangent and the end tangent in the dictionary as angles. The start tangent and the end tangent are used for the orientation of the node (object) specially yaw and pitch of the objects, respectively. Similarly, the pre-virtual environment generation and validation module 221 adds each node (road segment) from the dynamic list of the road network information to the dictionary. Length of each node is added to the start point and end point of the dictionary in form of co-ordinates 281, 283, 285, 287. Trigger value is to differentiate and draw different types of splines (explained below).

Nature of the node differentiates between static node and dynamic node. The pre-virtual environment generation and validation module 221 then loads the dictionary data into a game engine which is based on OpenGL and Vulkan drivers and spline is generated for the nodes (objects and roads) present in the driving environment i.e., the environment surrounding the AV 101 as shown in FIG. 2h. A spline is a dynamic trajectory which is defined for the nodes present in the driving environment i.e., the environment surrounding the AV 101. The pre-virtual environment generation and validation module 221 draws a spline for each node from starting point to the ending point with start tangent and end tangent also taken into consideration. The pre-virtual driving environment is generated by drawing the spline for all the nodes present in the driving environment as shown in FIG. 2h. With reference to FIG. 2h, the big square points 2892 are the spline points (start points and end points) and the small square points 2891 are the start tangent and end tangent. The curved line 2893 is the spline. Also, the small dotted box 287 is the floor on which spline is drawn. The pre-virtual driving environment is generated by drawing the spline for all the nodes present in the driving environment.

TABLE 1

| | | Start | End | | | Nature |
|---|---|---|---|---|---|---|
| | Trigger | Point | Point | Start | End | of the |
| Node | Value | (x, y) | (x, y) | Tangent | Tangent | Node |
| road | 1 | (0, 0) | (100, 0) | 0 | 0 | static |
| vehicle_1 | 2 | (40, 0) | (−20, 0) | 180 | 20 | dynamic |
| pedestrian_1 | 3 | (45, 0) | (45, 0) | 180 | 0 | static |
| vehicle_2 | 2 | (67, 0) | (67, 0) | 0 | 20 | static |
| pedestrian_2 | 3 | (50, 0) | (60, 0) | 270 | 10 | dynamic |

The pre-virtual environment generation and validation module 221 validates the pre-virtual driving environment. Due to inaccuracies/noise in the information from the one or more sensors 1021, there is a very high probability of false negative and false positive resulting in incorrect placement of nodes in the pre-virtual driving environment. To avoid such inconsistencies, the pre-virtual environment generation and validation module 221 checks/validates the pre-virtual driving environment through validation algorithm containing configurable validation rules to detect any inaccuracies. The configurable validation rules comprise of rules such as:
The nodes should not overlap
The nodes should not be outside of the small dotted box 287 in FIG. 2h
There should not be a collision between the nodes
Object nodes such as vehicle should not be outside of road nodes
Traffic rules and driving style (based on the region or location) i.e., Right/Left hand driving

The above-mentioned configurable validation rules are configurable parameters that change based on a driving region targeted. For instance, if the splines (vehicle 293 in FIG. 2i) in the pre-virtual driving environment are outside a pre-defined boundary, the validation algorithm may identify the splines outside a pre-defined boundary using validation rules and generate inaccuracy data. The pre-virtual environment generation and validation module 221 provides the inaccuracy data to the pre-virtual environment correction module 223 which corrects the information based on the inaccuracy data.

The pre-virtual environment generation and validation module 221 also corrects the dictionary data based on the re-build dynamic tree-based model for the objects and re-generated road network information using dynamic list. The pre-virtual environment generation and validation module 221 then generates the pre-virtual driving environment and validates it for accuracy. If no inaccuracy is found, the corrected dictionary data is provided to the virtual environment generation module 225.

The pre-virtual environment correction module 223: The pre-virtual environment correction module 223 corrects the information received from the input capturing module 213 based on the inaccuracy data received from the pre-virtual environment generation and validation module 221 using a cognitive technique. The corrected information is then passed onto the input data processing module 215. The pre-virtual environment correction module 223 uses corrective algorithms (also known as cognitive algorithms) such as a regression technique and/or a clustering technique on the information to interpolate and correct the information. In case of an inaccuracy that the spline in the pre-virtual driving environment is outside the pre-defined boundary (vehicle 293 in FIG. 2i), the pre-virtual environment correction module 223 re-adjusts the values based on the corrected information to make the spline (vehicle 295 in FIG. 2i) more aligned to the pre-defined boundary. In case of inconsistency of object position due to different information related to the environment surrounding the AV from one or more sensors, the pre-virtual environment correction module 223 considers the information from the one or more sensors with higher priority based on the weather present in the environment surrounding the AV 101 i.e., cloudy, rainy, or sunny and time of day. For instance, in rainy scenario, priority is given to the information from the RADAR sensor as the camera and the LIDAR sensor have low accuracy in these conditions. In fog scenario, priority is given to the information from the LIDAR sensor and the RADAR sensor rather than the camera due to low visibility. One correction algorithm (cognitive algorithm shown in Equation 1) that is used by the pre-virtual environment correction module 223 is based on the clustering technique. This technique builds different clusters for each sensor and based on if the clusters satisfy an objective function this technique assigns that sensor value as corrected information. The clustering technique is based on objective function where the centroid with the minimum Euclidean distance is selected as an optimal sensor.

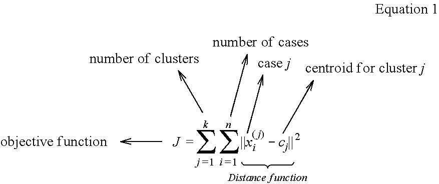

Another correction algorithm (cognitive algorithm shown in Equation 2) that is used by the pre-virtual environment correction module 223 is based on the regression technique. The objective function for regression technique is based on Root Mean Square Error (RMSE) where the yᵢ is the correct labels and ŷ is the predicted label.

$$RMSE = \sqrt{\frac{1}{n} {\sum }_{i = 1}^{n} {( {y}_{i} - \hat{y} )}^{2}} \qquad Equation 2$$

The virtual environment generation module 225: The virtual environment generation module 225 re-generates the virtual driving environment for the AV 101 using the pre-virtual driving environment and the corrected information. The virtual environment generation module 225 loads the corrected dictionary data into a game engine that is based on OpenGL and Vulkan drivers. The virtual environment generation module 225 then loads an empty virtual environment into the game engine. The virtual environment generation module 225 further loads different 3Dimensional (3D) model such as pedestrian, cars, buildings into the game engine as mentioned in the corrected dictionary data. In one embodiment, the virtual environment generation module 225 includes environmental effect or weather conditions to the virtual driving environment for the AV 101 based on the weather node 267 as shown in FIG. 2d. The virtual environment generation module 225 defines a scaling parameter for the virtual driving environment that can reduce or increase the computation on the system in terms of hardware (RAM, hard disk and the like). This module 225 then reads the corrected dictionary data starting with the road nodes and draws spline for the same road nodes. Thereafter, this module 225 places the road in the virtual driving environment on top of the spline of the road nodes. The virtual environment generation module 225 then draws spline for the object nodes and 3D models for the objects are placed over the start point and the end point of splines for all the object nodes. The virtual environment generation module 225 then uses the start tangent and the end tangent of the spline to adjust the orientation of the 3D models of the objects and also, creates different levels with different weather conditions and time of the day based on the weather information. The virtual environment generation module 225 uses the velocity data/information for movement control of 3D models of the objects. The (final) virtual driving environment is then generated as shown in FIG. 2j and provided for display.

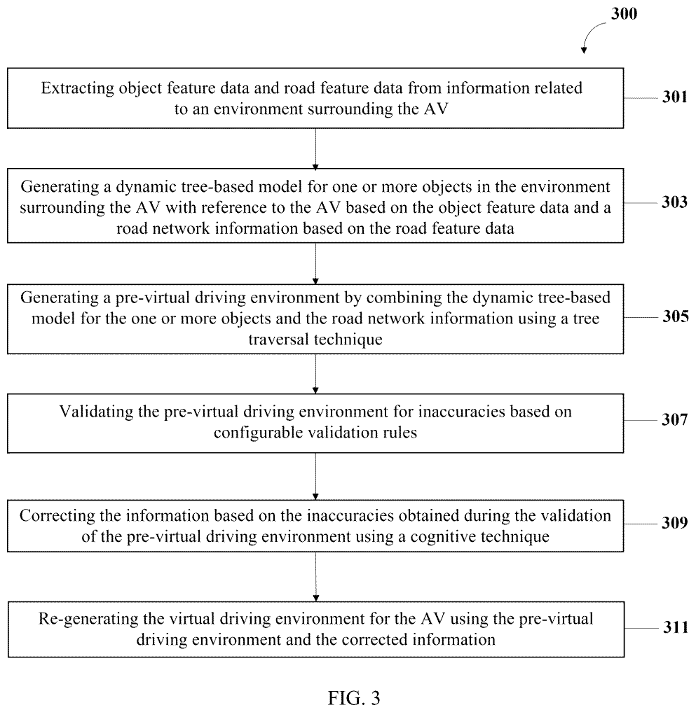

FIG. 3 illustrates a flowchart showing a method of generating a virtual driving environment for an AV, in accordance with some embodiments of present disclosure.

As illustrated in FIG. 3, the method 300 includes one or more blocks for generating the virtual driving environment for the AV 101. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the input data processing 215 of the virtual driving environment generating system 107 may extract object feature data and road feature data from information related to an environment surrounding the AV. The information may comprise at least one of environmental data, odometer data, Simultaneous Localization and Mapping (SLAM) data, and data related to vehicles, road network, markings on roads, pedestrians, sign-boards, traffic, vegetation and traffic lights. The one or more objects may comprise at least one of one or more pedestrians, one or more vehicles and one or more traffic elements present in the environment surrounding the AV. The object feature data may comprise a number of one or more objects present in the environment surrounding the AV 101, type of the one or more objects present in the environment surrounding the AV 101, state of the one or more objects, distance of the one or more objects from the AV 101, velocity of the one or more objects with respect to the AV 101, direction of the one or more objects with respect to the AV 101, orientation of the one or more objects with respect to the AV 101, weather present in the environment surrounding the AV 101 and time of day. The road feature data may comprise at least one of drivable road region and road information.

At block 303, the object tree generating module 217 of the virtual driving environment generating system 107 may generate a dynamic tree-based model for one or more objects in the environment surrounding the AV 101 with reference to the AV 101 based on the object feature data and road network information based on the road feature data. The objects may comprise at least one of one or more pedestrians and one or more vehicles present in the environment surrounding the AV 101.

At block 305, the pre-virtual environment generation and validation module 221 of the virtual driving environment generating system 107 may generate a pre-virtual driving environment by combining the dynamic tree-based model for the objects and the road network information using a tree traversal technique that gets converted into a dynamic list. The tree traversal technique may be a breadth-first search technique.

At block 307, the pre-virtual environment generation and validation module 221 of the virtual driving environment generating system 107 may generate and validate the pre-virtual driving environment for inaccuracies based on configurable validation rules.

At block 309, the pre-virtual environment correction module 223 of the virtual driving environment generating system 107 may correct the information based on the inaccuracies obtained during the validation of the pre-virtual driving environment using a cognitive technique. The cognitive technique may be at least one of a clustering technique and a regression technique.

At block 311, the virtual environment generation module 225 of the virtual driving environment generating system 107 may re-generate the virtual driving environment for the AV 101 using the pre-virtual driving environment and the corrected information.

Some of the advantages of the present disclosure are listed below.

The present disclosure automates the process of virtual driving environment generation by generating a pre-virtual driving environment, validating the pre-virtual driving environment for inaccuracies and correcting the information based on the inaccuracies. This approach improves accuracy and efficiency of the virtual driving environment generation process.

Typically, a virtual driving environment is created manually using one or more developers. This manual process is tedious and time consuming, and there is a high possibility to miss lots of minute details of a real-world environment in generating the virtual driving environment. The present disclosure overcomes these problems associated with the manual process.

The present disclosure allows generation of new synthetic dataset to be used by ML algorithms for training purpose and their validation.

Any mismatch or gap in collected/received information related to an environment surrounding the AV can alter vehicle's manoeuvring behaviour. The present disclosure allows coverage of static as well as dynamic objects related to the environment surrounding the AV into the virtual driving environment using one or more sensors to avoid any loss of information.

Additionally, the present disclosure considers road network information such as a length of a road, a width of the road, an elevation of the road and a curvature of the road along with dynamic state of objects to provide a realistic virtual driving environment.

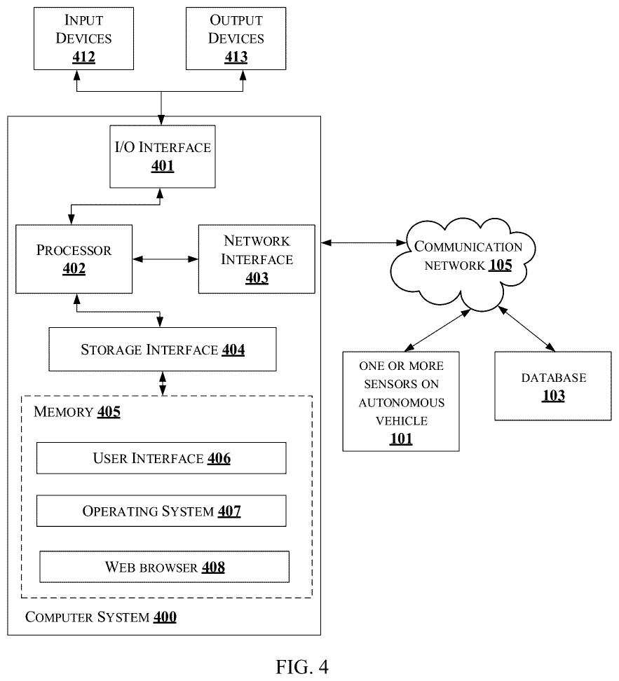

FIG. 4 illustrates a block diagram of an exemplary computer system 400 for implementing embodiments consistent with the present disclosure. In an embodiment, the computer system 400 may be used to implement the virtual driving environment generating system 107. The computer system 400 may include a central processing unit (“CPU” or “processor”) 402. The processor 402 may include at least one data processor for generating a virtual driving environment for an AV. The processor 402 may include specialized processing units such as, integrated system (bus) controllers, memory management control units, floating point units, graphics processing units, digital signal processing units, etc.

The processor 402 may be disposed in communication with one or more input/output (I/O) devices (not shown in FIG. 4) via I/O interface 401. The I/O interface 401 employ communication protocols/methods such as, without limitation, audio, analog, digital, monoaural, Radio Corporation of America (RCA) connector, stereo, IEEE®-1394 high speed serial bus, serial bus, Universal Serial Bus (USB), infrared, Personal System/2 (PS/2) port, Bayonet Neill-Concelman (BNC) connector, coaxial, component, composite, Digital Visual Interface (DVI), High-Definition Multimedia Interface (HDMI®), Radio Frequency (RF) antennas, S-Video, Video Graphics Array (VGA), IEEE® 802.11b/g/n/x, Bluetooth, cellular e.g., Code-Division Multiple Access (CDMA), High-Speed Packet Access (HSPA+), Global System for Mobile communications (GSM®), Long-Term Evolution (LTER), Worldwide interoperability for Microwave access (WiMax®), or the like.

Using the I/O interface 401, the computer system 400 may communicate with one or more I/O devices such as input devices 412 and output devices 413. For example, the input devices 412 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 413 may be a printer, fax machine, video display (e.g., Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc.

In some embodiments, the computer system 400 consists of the virtual driving environment generating system 107. The processor 402 may be disposed in communication with the communication network 105 via a network interface 403. The network interface 403 may communicate with the communication network 105. The network interface 403 may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc. The communication network 105 may include, without limitation, a direct interconnection, Local Area Network (LAN), Wide Area Network (WAN), wireless network (e.g., using Wireless Application Protocol), the Internet, etc. Using the network interface 403 and the communication network 105, the computer system 400 may communicate with the one or more sensors 1021 positioned on the AV 101 and the database 103. The network interface 403 may employ connection protocols include, but not limited to, direct connect, Ethernet (e.g., twisted pair 10/100/1000 Base T), Transmission Control Protocol/Internet Protocol (TCP/IP), token ring, IEEE® 802.11a/b/g/n/x, etc.

The communication network 105 includes, but is not limited to, a direct interconnection, a Peer to Peer (P2P) network, Local Area Network (LAN), Wide Area Network (WAN), wireless network (e.g., using Wireless Application Protocol), the Internet, Wi-Fi and such.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as, Serial Advanced Technology Attachment (SATA), Integrated Drive Electronics (IDE), IEEE®-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407, etc. In some embodiments, computer system 400 may store user/application data, such as, the data, variables, records, etc., as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like.

In some embodiments, the computer system 400 may implement web browser 408 stored program components. Web browser 408 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, ADOBE® FLASH®, JAVASCRIPT®, JAVA®, Application Programming Interfaces (APIs), etc. The computer system 400 may implement a mail server (not shown in FIG. 4) stored program component. The mail server may be an Internet mail server such as Microsoft Exchange, or the like. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. The computer system 400 may implement a mail client (not shown in FIG. 4) stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

### REFERRAL NUMERALS

| Reference number | Description |
|---|---|
| 100 | Environment |
| 101 | Autonomous vehicle |
| 1021₁, 1021₂, . . . 1021_{N} | One or more sensors |
| 1022 | ADAS/AV validation system |
| 103 | Database |
| 105 | Communication network |
| 107 | Virtual driving environment generating system |
| 111 | I/O interface |
| 113 | Memory |
| 115 | Processor |
| 200 | Data |
| 201 | Sensor data |
| 203 | Other data |
| 211 | Modules |
| 213 | Input capturing module |
| 215 | Input data processing module |
| 217 | Object tree generation module |
| 219 | Road building module |
| 221 | Pre-virtual environment generation and |
| | validation module |
| 223 | Pre-virtual environment correction module |
| 225 | Virtual environment generation module |
| 227 | Other modules |
| 231, 233, 235, 237, 239, | Object feature data |
| 241, 243, 245, 247 | |
| 400 | Computer system |
| 401 | I/O interface |
| 402 | Processor |
| 403 | Network interface |
| 404 | Storage interface |
| 405 | Memory |
| 406 | User interface |
| 407 | Operating system |
| 408 | Web browser |
| 412 | Input devices |
| 413 | Output devices |

What is claimed is:

1. A method of generating a virtual driving environment for an Autonomous Vehicle (AV), the method comprising:
extracting object feature data and road feature data from information related to an environment surrounding the AV;
generating a dynamic tree-based model for one or more objects in the environment surrounding the AV with reference to the AV based on the object feature data and road network information based on the road feature data;
generating a pre-virtual driving environment by combining the dynamic tree-based model for the one or more objects and the road network information using a tree traversal technique;
validating the pre-virtual driving environment for inaccuracies based on configurable validation rules;
correcting the information based on the inaccuracies obtained during the validation of the pre-virtual driving environment using a cognitive technique; and
re-generating the virtual driving environment for the AV using the pre-virtual driving environment and the corrected information.

2. The method as claimed in claim 1, wherein prior to extracting object feature data and road feature data from information related to an environment surrounding the AV, the method comprises:
receiving the information related to the environment surrounding the AV from one or more sensors.

3. The method as claimed in claim 1, wherein the information comprises at least one of environmental data, odometer data, Simultaneous Localization and Mapping (SLAM) data, and data related to vehicles, road network, markings on roads, pedestrians, sign-boards, traffic, vegetation and traffic lights.

4. The method as claimed in claim 1, wherein the object feature data comprises a number of one or more objects present in the environment surrounding the AV, type of the one or more objects present in the environment surrounding the AV, state of the one or more objects, distance of the one or more objects from the AV, velocity of the one or more objects with respect to the AV, direction of the one or more objects with respect to the AV, orientation of the one or more objects with respect to the AV, weather present in the environment surrounding the AV and time of day, and region in which the AV is present.

5. The method as claimed in claim 1, wherein the one or more objects comprise at least one of one or more pedestrians, one or more vehicles and one or more traffic elements present in the environment surrounding the AV.

6. The method as claimed in claim 1, wherein the road feature data comprises at least one of drivable road region and road information.

7. The method as claimed in claim 1, wherein the tree traversal technique is a breadth-first search technique.

8. The method as claimed in claim 1, wherein the cognitive technique is at least one of a clustering technique and a regression technique.

9. A virtual driving environment generating system for generating a virtual driving environment for an Autonomous Vehicle (AV), the virtual driving environment generating system comprising:
a processor; and
a memory communicatively coupled to the processor, wherein the memory stores processor-executable instructions, which on execution, cause the processor to:
extract object feature data and road feature data from information related to an environment surrounding the AV;
generate a dynamic tree-based model for one or more objects in the environment surrounding the AV with reference to the AV based on the object feature data and road network information based on the road feature data;
generate a pre-virtual driving environment by combining the dynamic tree-based model for the one or more objects and the road network information using a tree traversal technique;
validate the pre-virtual driving environment for inaccuracies based on configurable validation rules;
correct the information based on the inaccuracies obtained during the validation of the pre-virtual driving environment using a cognitive technique; and
re-generate the virtual driving environment for the AV using the pre-virtual driving environment and the corrected information.

10. The virtual driving environment generating system as claimed in claim 9, wherein prior to extracting object feature data and road feature data from information related to an environment surrounding the AV, the processor is configured to:
receive the information related to the environment surrounding the AV from one or more sensors.

11. The virtual driving environment generating system as claimed in claim 9, wherein the information comprises at least one of environmental data, odometer data, Simultaneous Localization and Mapping (SLAM) data, and data related to vehicles, road network, markings on roads, pedestrians, sign-boards, traffic, vegetation and traffic lights.

12. The virtual driving environment generating system as claimed in claim 9, wherein the object feature data comprises a number of one or more objects present in the environment surrounding the AV, type of the one or more objects present in the environment surrounding the AV, state of the one or more objects, distance of the one or more objects from the AV, velocity of the one or more objects with respect to the AV, direction of the one or more objects with respect to the AV, orientation of the one or more objects with respect to the AV, weather present in the environment surrounding the AV and time of day, and region in which the AV is present.

13. The virtual driving environment generating system as claimed in claim 9, wherein the one or more objects comprise at least one of one or more pedestrians, one or more vehicles present in the environment surrounding the AV and one or more traffic elements.

14. The virtual driving environment generating system as claimed in claim 9, wherein the road feature data comprises at least one of drivable road region and road information.

15. The virtual driving environment generating system as claimed in claim 9, wherein the tree traversal technique is a breadth-first search technique.

16. The virtual driving environment generating system as claimed in claim 9, wherein the cognitive technique is at least one of a clustering technique and a regression technique.

17. A non-transitory computer readable medium including instructions stored thereon that when processed by at least one processor cause a virtual driving environment generating system to perform operations comprising:
extracting object feature data and road feature data from information related to an environment surrounding the AV;
generating a dynamic tree-based model for one or more objects in the environment surrounding the AV with reference to the AV based on the object feature data and road network information based on the road feature data;
generating a pre-virtual driving environment by combining the dynamic tree-based model for the one or more objects and the road network information using a tree traversal technique;
validating the pre-virtual driving environment for inaccuracies based on configurable validation rules;
correcting the information based on the inaccuracies obtained during the validation of the pre-virtual driving environment using a cognitive technique; and
re-generating the virtual driving environment for the AV using the pre-virtual driving environment and the corrected information.

18. The medium as claimed in claim 17, wherein prior to extracting object feature data and road feature data from information related to an environment surrounding the AV, the instructions cause the at least one processor to:
receive the information related to the environment surrounding the AV from one or more sensors.

19. The medium as claimed in claim 17, wherein the one or more objects comprise at least one of one or more pedestrians, one or more vehicles and one or more traffic elements present in the environment surrounding the AV; and
wherein the road feature data comprises at least one of drivable road region and road information.

20. The medium as claimed in claim 17, wherein the tree traversal technique is a breadth-first search technique; and
wherein the cognitive technique is at least one of a clustering technique and a regression technique.
